(19) United States
(12) Patent Application Publication
(10) Pub. No.: US 2008/0109162 A1
(43) Pub. Date: May 8, 2008

(54) Vehicle dynamic navigation system and method

(75) Inventors: Kuo-Rong Chen, Panchiao City (TW); Chun-Chung Lee, Taipei (TW); Ming-Wen Yang, Sinjhuang City (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/652,113

(22) Filed: Jan. 11, 2007

(30) Foreign Application Priority Data
Nov. 6, 2006 (TW) 095140937

(51) Int. Cl. G01C 21/34

(52) U.S. Cl. 701/210

(57) ABSTRACT

A vehicle dynamic navigation method and system in which an on-vehicle main unit calculates a total navigation path subject to the set start location and destination, and transmits a position information indicative of the vehicle's current position received from a global positioning system through a wireless transceiver to a remote traffic information server so as to obtain a real-time traffic-problem location data of a neighboring area from the remote traffic information server, and then constitutes a district navigation path based on the part of the total navigation path within the neighboring area, and then determines whether the district navigation path and the traffic-problem location data overlap each other, and then re-proposes the district navigation path when the district navigation path and the traffic-problem location data are found to overlap.

### BACKGROUND OF THE INVENTION

1. Field of the Invention

The present invention relates to the vehicle navigation technology and more particularly, to a vehicle dynamic navigation method and system.

2. Description of Related Art

FIG. 1 shows a vehicle carrying a convention navigation system. The navigation system comprises a GPS (Global Positioning System) 81, a navigation device 82, and a display 83. The GPS 81 receives signals from multiple global position satellites 9 for calculating the coordinates of the vehicle's current position. The microprocessor 821 of the navigation device 82 compares the coordinates of the vehicle's current position to the built-in electronic map database 822 to determine the corresponding location of the vehicle's current position on map data in the electronic map database 822, and then shows a sign and the map data on the display 83, for enabling the driver to know the road on which the vehicle is traveling and actual location of the vehicle's current position in real time.

The function of road navigation is to let the driver set a location of departure and a location of destination, and to use an optimal path selection algorithm (for example, Dijkstra's algorithm) to determine the shortest route, i.e., the so-called “suggested travel path” between the two locations. Thereafter, the navigation device always records the vehicle's traveling path and points out front entrance and direction of turn subject to the suggested travel path and road position function. Further, the road navigation function always monitors whether the vehicle is moving along the suggested travel path all the time. If the vehicle deviates from the suggested travel path, the navigation system calculates a shortest path to the destination as a new suggested travel path subject to the current position and traveling direction of the vehicle.

However, a conventional navigation system simply considers the shortest path from the location of departure to the location of destination without taking traffic-problem locations or actual traffic conditions into account when proposing a suggested travel path, and the suggested travel path may be the shortest path in distance but the duration of the journey may be very long. That is, the driver may have to spend a longer time to reach the destination through the suggested travel path because of factors unknown.

To eliminate the aforesaid problem, providers have developed different real-time navigation software systems that join a traffic information system (such as PaPaGo™). The functioning of these designs is outlined hereinafter.

After the driver has set a location of departure of trip and a location of destination of trip, the on-vehicle main unit (not shown) obtains all traffic delay information such as congestion, flooding etc from a traffic information server and calculates the shortest path to the destination beyond the traffic-problem locations subject to the obtained relevant location information. FIG. 2 is a schematic drawing showing a suggested travel path subject to the traffic-problem location information provided by a traffic information server according to the prior art. After the driver has set a locations of departure A and a location of destination C, the on-vehicle main unit obtains from the traffic information server a traffic flow location information of road R220, knowing the location J1 of a traffic jam on road R220. The on-vehicle main unit calculates R210-R230 to be the “suggested travel path” subject to the navigation function and the location J1 of a traffic jam. This method is to download the information of all traffic-problem locations at one time. However, when traffic jams have occurred in many places due to extraordinary conditions, or when traveling in very large territory area where traffic information is complex, the information transmission time will be long, adding an economic burden to the driver or causing the driver to be unable to get away from the jammed road segment.

Further, to avoid download of all traffic congestion location information from a traffic information server, a navigation method is disclosed in which a remote server calculates all possible suggested navigation paths and compares these suggested navigation paths to traffic congestion information, and then sends the traffic jam information of all possible paths back to the on-vehicle main unit. This method eliminates the necessity of downloading all traffic jam information, however it still has drawbacks such as follows:

1. It cannot provide detailed traffic jam information in real time.

2. The traffic jam information provided by the remote server contains the traffic jam information of all possible navigation paths. Therefore, this method cannot eliminate the problem of high transmission charge due to the large amount of traffic jam information.

3. The remote server must compute and compare all possible paths, and the on-vehicle main unit can propose the travel path only after download of the traffic jam information from the remote server, thereby resulting in the following problems:
a. Increase of the driver's waiting time during navigation.
b. High probability of machine shutdown due to overload of the remote server.
c. Low marketability due to high construction cost of the remote server.

4. It cannot obtain the traffic jam information when not in the navigation mode.

5. It does not provide an option for allowing the driver to decide whether or not to avoid the path having a traffic jam.

Therefore, it is desirable to provide a navigation method and system that eliminates the aforesaid problems.

### SUMMARY OF THE INVENTION

The present invention has been accomplished under the circumstances in view. It is therefore the main object of the present invention to provide a vehicle dynamic navigation method and system, which dynamically determines whether the travel path goes through a traffic-problem location during navigation, so as to guide traveling of the vehicle away from the congested or blocked road segment. It is another object of the present invention to provide a vehicle dynamic navigation method and system, which continuously updates real-time traffic-problem location data corresponding to each neighboring area around the current position of the vehicle.

To achieve these and other objects of the present invention, the vehicle dynamic navigation method comprising the steps of: (a) an on-vehicle main unit calculating a total navigation path subject to a predetermined location of a start point of a trip and a predetermined location of a destination of the trip; (b) the on-vehicle main unit receiving from a positioning system position information of the location of the vehicle on which the on-vehicle main unit is installed, and transmitting the position information to a remote traffic information server by means of a wireless transceiver; (c) the remote traffic information server providing traffic-problem location data of at least one predetermined neighboring area and transmitting the traffic-problem location data to the on-vehicle main unit subject to the position information; (d) the on-vehicle main unit constituting a district navigation path subject to the road segment of the total navigation path that is covered by the at least one neighboring area, and determining whether the district navigation path and the traffic-problem location data overlap; and (e) re-proposing the district navigation path when the district navigation path and the traffic jammed location data do overlap.

The vehicle dynamic navigation system is installed in a vehicle to guide the vehicle, comprising an input device adapted to input a location of a destination of a trip and an update interval, a global positioning system adapted to output the current position of the vehicle, an electronic map database, which has stored therein multiple items of road map data, a display screen for display of road map data regarding the current position of the vehicle, a wireless transceiver, and an on-vehicle main unit, which is respectively electrically coupled to the input device, the global positioning system, the electronic map database, the display screen, and the wireless transceiver. The on-vehicle main unit reads in the location of the destination of the trip and the update interval from the input device and the current position of the vehicle from the global positioning system, sets the current position of the vehicle to be a location of a start point of the trip, and calculates a total navigation path subject to the location of the start point of the trip and the location of the destination of the trip and the road map data of the electronic map database. The on-vehicle main unit transmits a position information indicative of the current position of the vehicle received from the global positioning system through the wireless transceiver to a remote traffic information server so as to obtain a real-time traffic-problem location data of at least one predetermined neighboring area from the remote traffic information server through the wireless transceiver, and constitutes a district navigation path based on the part of the total navigation path within the at least one predetermined neighboring area, and determines whether the district navigation path and the traffic-problem location data overlap, and re-proposes the district navigation path when the district navigation path and the traffic-problem location data do overlap.

### BRIEF DESCRIPTION OF THE DRAWINGS

FIG. 1 is a system block diagram of a vehicle navigation system according to the prior art.

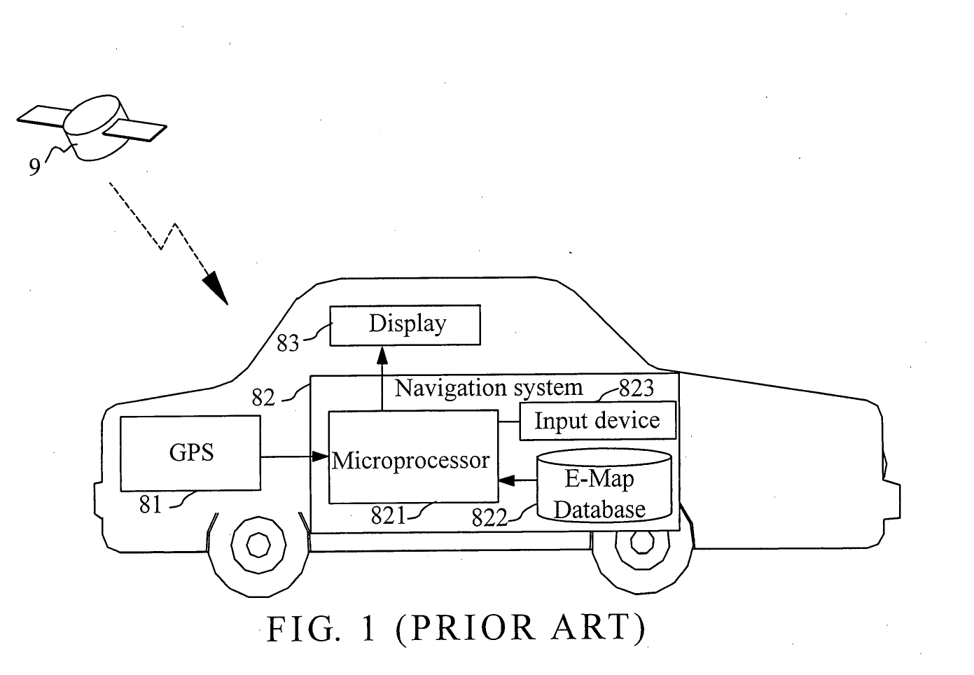

FIG. 2 is a schematic drawing showing a suggested travel path subject to the traffic-problem locations provided by a traffic information server according to the prior art.

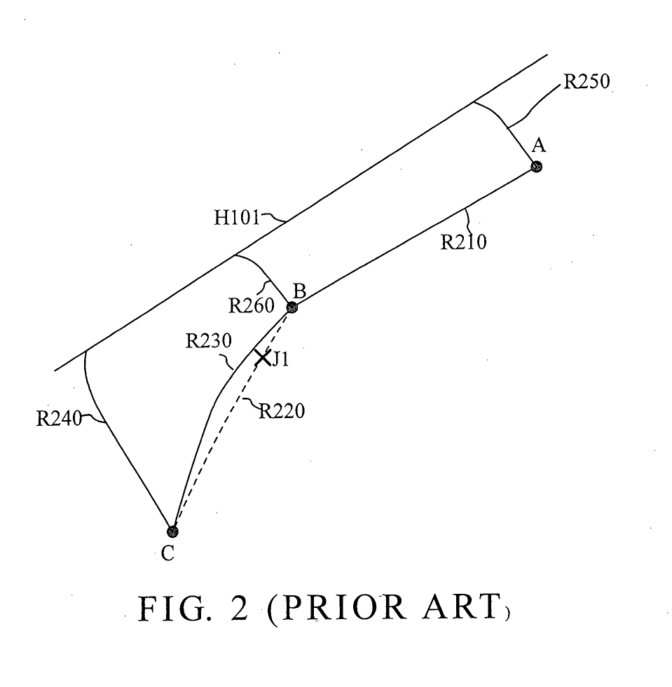

FIG. 3 is a system block diagram of a vehicle dynamic navigation system according to the present invention.

FIG. 4 is a flow chart of a vehicle dynamic navigation method according to the present invention.

FIG. 5 is a table showing different radius ranges of the neighboring area calculated by the traffic information server subject to different update intervals according to the present invention.

FIG. 6 is a schematic drawing showing the operation of the vehicle dynamic navigation system according to the present invention.

### DETAILED DESCRIPTION OF THE PREFERRED EMBODIMENT

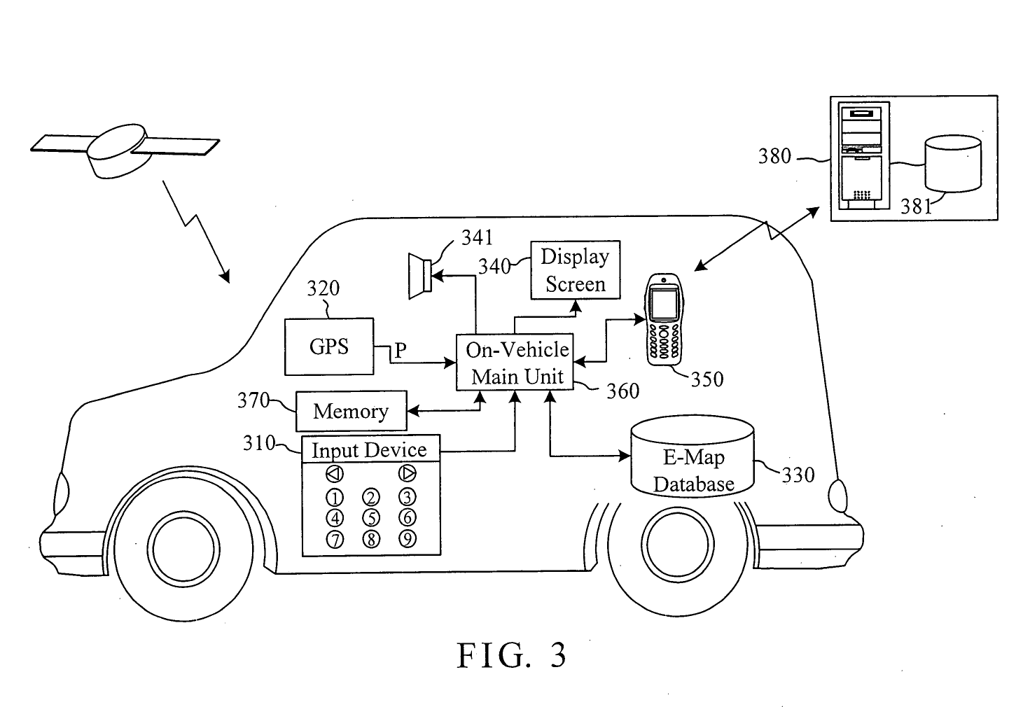

FIG. 3 is a system block diagram of a vehicle dynamic navigation system according to the present invention. As illustrated, the dynamic navigation system comprises an input device 310, a GPS (global positioning system) 320, an electronic map database 330, a display screen 340, a speaker 341, a wireless transceiver 350, an on-vehicle main unit 360, and a memory device 370.

The input device 310 is adapted for inputting a start point S of a trip, an end point E of the trip, and an update interval t. The GPS 320 is adapted to output the vehicle's current position Pc. In other embodiments, the start point S of the trip can be the vehicle's current position Pc outputted by the GPS 320. The update interval t can be stored in the memory device 370.

The electronic map database 330 has stored therein multiple items of road map information. The road map information includes the names of multiple roads, and the coordinates of the start point and end point of each of the roads.

The display screen 340 is adapted to display the road map information corresponding to the vehicle's current position. The speaker 340 is adapted to broadcast music or voice messages.

The wireless transceiver 350 is adapted to transmit position information of the vehicle's current position obtained from the GPS 320 to a remote traffic information server 380 through a wireless network. The position information includes the aforesaid update interval t. The wireless network can be a mobile communication network such as GPRS, WCDMA, CDMA2000, etc. The wireless transceiver 350 can be a mobile phone of GSM, WCDMA, CDMA200, or any of a variety of other communication systems that provide a data transmission function.

The on-vehicle main unit 360 is electrically coupled to the input device 310, the GPS 320, the electronic map database 330, the display screen 340, the speaker 341, and the wireless transceiver 350, and adapted to initialize and set the input device 310, the GPS 320, the electronic map database 330, the display screen 340, the speaker 341, and the wireless transceiver 350.

By means of the input device 310, a driver can input a start point S of the trip, an end point E of the trip, and an update interval t. The on-vehicle main unit 360 calculates the total navigational path R1 of the vehicle subject to the inputted start point S of the trip and the end point E of the trip and the road map information in the electronic map database 330.

The on-vehicle main unit 360 calculates the shortest or quickest total navigational path R1 between the start point S of the trip and the end point E of the trip by means of an optimal path selection algorithm (for example, Dijkstra's algorithm).

The wireless transceiver 350 transmits the position information to the remote traffic information server 380 through the wireless network. The position information includes the vehicle's current position Pc and update interval t.

Based on the vehicle's current position Pc, the remote traffic information server 380 receives the data of traffic-problem locations J1, J2 . . . in at least one corresponding predetermined neighboring area Ac, and downloads the data of traffic-problem locations J1, J2 . . . to the wireless transceiver 350 wirelessly.

After the wireless transceiver 350 and the remote traffic information server 380 have constituted a wireless link, the wireless transceiver 350 can transmit the position information to the remote traffic information server 380 through the wireless link and receive the real-time data of traffic-problem locations J1, J2 . . . from the remote traffic information server 380. The wireless link will be disconnected only after finish of the data transmitting and receiving actions. Therefore, the position information does not contain a PIN (Personal Identification Number) of the wireless transceiver 350. However, in other embodiments, the position information can contain a PIN of the wireless transceiver 350, and the remote traffic information server 380 can execute charge calculations or other services subject to the PIN of the wireless transceiver 350.

The on-vehicle main unit 360 constitutes a district navigation path based on the part of the total navigation path within the neighboring area Ac, and determines whether the district navigation path and the traffic-problem locations J1, J2 . . . overlap. When the district navigation path and the traffic-problem locations J1, J2 . . . do overlap, the on-vehicle main unit 360 outputs an inquiry, informing the driver to re-propose the district navigation path. The inquiry outputted by the on-vehicle main unit 360 is an inquiry window displayed on the display screen 340. The inquiry outputted by the on-vehicle main unit 360 can be a voice inquiry performed by the speaker 341.

When the on-vehicle main unit 360 determines to re-propose the district navigation path, the on-vehicle main unit 360 re-proposes another district navigation path, which is the optimal path from the vehicle's current position Pc to the end point E of the trip without having to travel through the traffic-problem locations J1, J2 . . . in the corresponding neighboring area Ac.

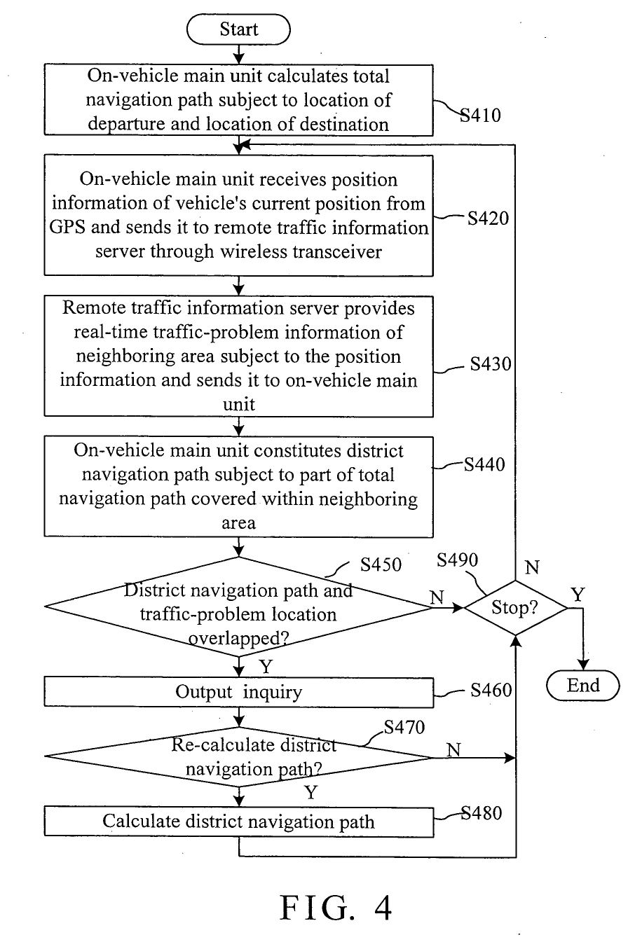

FIG. 4 is a flow chart of a vehicle dynamic navigation method according to the present invention.

First, in step S410, one on-vehicle main unit 360 that is carried on a vehicle calculates a total navigation path R1 subject to a start point S of a trip and an end point E of the trip.

In step S410, the on-vehicle main unit 360 is electrically coupled to a GPS 320 on the said vehicle to fetch the current position Pc of the vehicle outputted by the GPS 320 and to set the current position Pc of the vehicle as the start point S of trip.

In step S410, the on-vehicle main unit 360 is electrically coupled to an input device 310 for inputting the end point E of the trip and an update interval t. In another embodiment, the on-vehicle 360 is electrically coupled to a memory 370 that has stored therein the said update interval t, and to read in the update interval t from the memory 370.

In step S410, the on-vehicle main unit 360 calculates the said total navigation path R1 subject to the start point S of the trip and the end point E of the trip. The total navigation path R1 is the optimal path from the start point S of the trip to the end point E of the trip. Thereafter, the on-vehicle main unit 360 guides the vehicle to travel from the start point S of the trip to the end point E of the trip.

In step 420, the on-vehicle main unit 360 receives position information of the location of the vehicle from a positioning system, and transmits the position information to a remote traffic information server 380 through a wireless transceiver 350. The position information includes the vehicle's current position Pc and the update interval t. The position system includes a GPS module (Global Positioning System Module) 320.

The remote traffic information server 380 has stored therein multiple real-time traffic-problem locations J1, J2 . . . . The remote traffic information server 380 is connected through the Internet to Highway Bureau, Department of Transportation of every county, and police department's broadcast station to receive real-time traffic-problem locations J1, J2 . . . and other traffic information of different locations and to update the data at anytime.

In step S430, the remote traffic information server 380 provides the information of real-time traffic-problem locations J1, J2 . . . of at least one neighboring area Ac, and transmits the information to the on-vehicle main unit 360.

The neighboring area Ac is a neighboring geo-zone around the vehicle's current position Pc, having a specific geo boundary. The specific geo boundary is the circular area within a specific radius r based on the center at the vehicle's current position Pc, in which the specific radius r is directly proportional to the update interval t. In other embodiments, the specific geo boundary can be an oval, square, rectangle, or any of a variety of polygonal geo zones.

In step S430, the traffic information server 380 selects two corresponding neighboring areas Ac, including a first neighboring area Ac1 corresponding to a plain road and a second neighboring area Ac2 corresponding to a highway. The specific radius r1 of the first neighboring area Ac1 is smaller than the specific radius r2 of the second neighboring area Ac2.

On the plain road, the traffic information server 380 calculates the radius of the first neighboring area Ac1 subject to the following equation:

r1=V×t×(1+α) (1)

in which, r1 is the specific radius; V is the speed of the vehicle; t is the update interval; and α is a first correction efficient, preferably 0.3.

On the highway, the traffic information server 380 calculates the radius of the second neighboring area Ac2 subject to the following equation:

r2=V×t×(1+β) (2)

in which, r2 is the specific radius; V is the speed of the vehicle; t is the update interval; and β is a second correction efficient, preferably 0.5.

On the plain road, in the conditions of speed limit 70 km/hr, updating traffic information once per every 10 minutes, and the first correction efficient is 0.3, the radius r1 of the first neighboring area Ac1 should be 70×(10/60)×(1+30%)≈15 km radius.

On the highway, in the conditions of speed limit 110 km/hr, updating traffic information once per every 10 minutes, and the second correction efficient is 0.5, the radius r2 of the second neighboring area Ac2 should be 110×(10/60)×(1+50%)≈28 km radius.

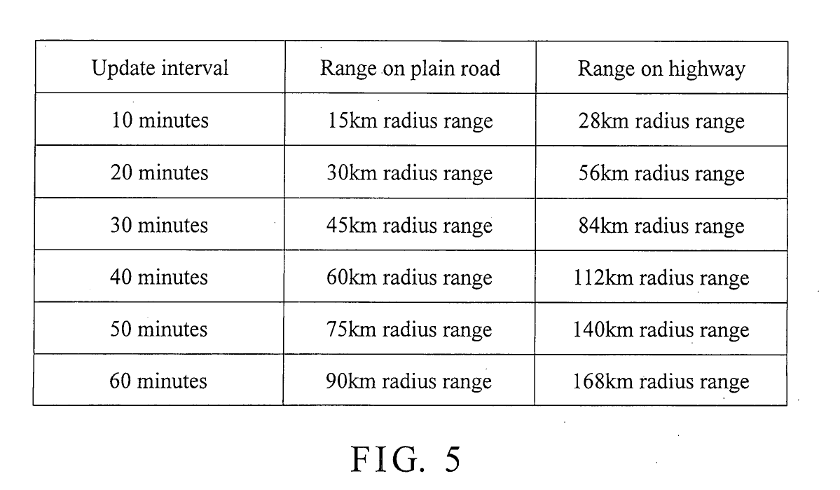

FIG. 5 is a table showing different radiuses of the neighboring area Ac calculated by the traffic information server 380 subject to different update intervals t. The traffic information server 380 calculates the radius of the neighboring area Ac subject to equations (1) and (2) and the update interval t. The traffic information server 380 also stores the table shown in FIG. 5 in a database 381 or memory device (not shown), and fetches the radius of the neighboring area Ac based on the index of the update interval t by means of table look up for searching the data of the traffic-problem locations within the radius of the neighboring area Ac.

In step S440, the on-vehicle main unit 360 constitutes a district navigation path subject to the segment of the total navigation path within the neighboring area Ac. The on-vehicle main unit 360 also determines whether the district navigation path and the real-time traffic-problem locations j1, j2 . . . overlap (Step S450).

When it is determined that the district navigation path and the real-time traffic-problem locations j1, j2 . . . do not overlap during step S450, the on-vehicle main unit 360 determines whether or not to end the flow (Step S490), and then ends the flow when the answer is yes, or runs step S420 after the update interval t is up when the answer is no.

When it is determined that the district navigation path and the real-time traffic-problem locations j1, j2 . . . do overlap during step S450, the on-vehicle main unit 360 runs step S460. In step S460, the on-vehicle main unit 360 outputs an inquiry for selection whether or not to recalculate the district navigation path (Step S470).

In step S460, the on-vehicle main unit 360 is electrically coupled to a display screen 340, and the inquiry outputted by the on-vehicle main unit 360 is an inquiry window displayed on the display screen 340. The on-vehicle main unit 360 can also be coupled to a speaker 341, and the inquiry outputted by the on-vehicle main unit 360 can be a voice inquiry outputted through the speaker 341.

When it is determined not to recalculate the district navigation path during step S470, the on-vehicle main unit 360 runs step S490.

When it is determined to recalculate the district navigation path during step S470, the on-vehicle main unit 360 runs step S480. During step S480, the on-vehicle main unit 360 calculates another district navigation path and then runs step S490. The said another district navigation path is the optimal path from the vehicle's current position Pc to the end point E of the trip without passing through the traffic-problem locations J1, J2 . . . .

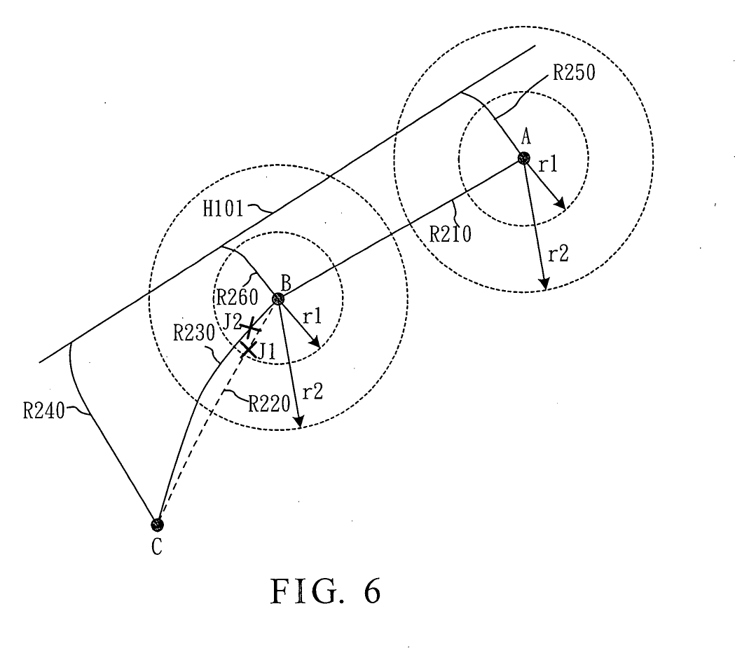

FIG. 6 is a schematic drawing showing the operation of the vehicle dynamic navigation system according to the present invention. After the driver of the vehicle has set a location of departure (start point) A and a location of destination (end point) C, the on-vehicle main unit 360 obtains from the traffic information server 380 a traffic-problem location on road R220, and learns that the traffic is jammed at location j1 on road R220. Based on the navigation function and the traffic-problem location J1, the on-vehicle main unit 360 determines R210-R230 to be the “suggested travel path”. When the driver drives the vehicle to point B, the traffic trouble at the traffic-problem location J1 may have been eliminated. In this case, subject to the technology of the present invention, the on-vehicle main unit 360 determines R210-R220 to be the “suggested travel path”, hence obtaining a relatively shorter travel path. In another condition, the traffic trouble at the traffic-problem location J1 may still exist and there may be yet another traffic-problem location J2 on road R230 when the driver drives the vehicle to point B. In this case, subject to the technology of the present invention, the on-vehicle main unit 360 dynamically determines a travel path to the destination C through road R260 to highway H101 and then to destination C via road R240.

As stated above, the present invention transmits position information to the remote traffic information server 380 and receives a real-time information of a traffic-problem location in a predetermined neighboring area Ac at every update interval t, thereby dynamically updating “travel path” to guide traveling of the vehicle away from jammed or interrupted road segments.

Although the present invention has been explained in relation to its preferred embodiment, it is to be understood that many other possible modifications and variations can be made without departing from the spirit and scope of the invention as hereinafter claimed.

What is claimed is:

1. A vehicle dynamic navigation method comprising the steps of:
(a) an on-vehicle main unit calculating a total navigation path subject to a predetermined location of a start point of a trip and a predetermined location of a destination of the trip;
(b) said on-vehicle main unit receiving from a positioning system position information of the location of the vehicle on which said on-vehicle main unit is installed, and transmitting said position information to a remote traffic information server by means of a wireless transceiver;
(c) said remote traffic information server providing traffic-problem location data of at least one predetermined neighboring area and transmitting the traffic-problem location data to said on-vehicle main unit subject to said position information;
(d) said on-vehicle main unit constituting a district navigation path subject to the road segment of said total navigation path that is covered by said at least one neighboring area, and determining whether said district navigation path and said traffic-problem location data overlap each other; and
(e) re-proposing said district navigation path when said district navigation path and said traffic problem location data have been determined to overlap each other.

2. The vehicle dynamic navigation method as claimed in claim 1, wherein said on-vehicle main unit outputs an inquiry for selection whether to re-propose said district navigation path after step (d), and runs step (e) when re-proposing said district navigation path is selected.

3. The vehicle dynamic navigation method as claimed in claim 1, wherein said district navigation path is contained in said total navigation path.

4. The vehicle dynamic navigation method as claimed in claim 1, wherein said on-vehicle main unit runs step (b) after a predetermined update interval when having determined during step (d) said district navigation path and said traffic-problem location data to not overlap each other.

5. The vehicle dynamic navigation method as claimed in claim 1, wherein said on-vehicle main unit is electrically coupled to a display screen during said step (e), and the inquiry outputted by said on-vehicle main unit is an inquiry window displayed on said display screen.

6. The vehicle dynamic navigation method as claimed in claim 1, wherein said on-vehicle main unit is electrically coupled to a speaker during step (e), and said inquiry outputted by said on-vehicle main unit is a voice inquiry outputted through said speaker.

7. The vehicle dynamic navigation method as claimed in claim 1, wherein said on-vehicle main unit is electrically coupled to an input device, said input device being adapted for inputting said predetermined location of start point of the trip, said predetermined location of destination of the trip, and said predetermined update interval; said position information transmitting to the remote traffic information server during step (b) contains said predetermined update interval.

8. The vehicle dynamic navigation method as claimed in claim 1, wherein said on-vehicle main unit is electrically coupled to memory means, said memory means having stored therein said predetermined update interval.

9. The vehicle dynamic navigation method as claimed in claim 1, wherein said positioning system that provides said position information to said on-vehicle main unit during step (b) comprises a global positioning system module.

10. The vehicle dynamic navigation method as claimed in claim 1, wherein said at least one predetermined neighboring area provided by said remote traffic information server during step (c) each is the circular area within a specific radius based on the center at the current position of the vehicle carrying said on-vehicle main unit.

11. The vehicle dynamic navigation method as claimed in claim 10, wherein said specific radius is directly proportional to said update interval.

12. The vehicle dynamic navigation method as claimed in claim 10, wherein said remote traffic information server provides traffic-problem location data of two neighboring areas during step (c), said two neighboring areas including a first neighboring area corresponding to a plain road and a second neighboring area corresponding to a highway, the specific radius of said first neighboring area being smaller than the specific radius of said second neighboring area.

13. A vehicle dynamic navigation system installed in a vehicle to guide traveling of said vehicle, comprising:
an input device adapted to input a location of a destination of a trip and an update interval;
a global positioning system adapted to output the current position of said vehicle;
an electronic map database, said electronic map database having stored therein multiple road map data;
a display screen for display of road map data regarding the current position of said vehicle;
a wireless transceiver; and
an on-vehicle main unit respectively electrically coupled to said input device, said global positioning system, said electronic map database, said display screen, and said wireless transceiver, and adapted to read in said location of the destination of the trip and said update interval from said input device and the current position of said vehicle from said global positioning system, to set the current position of said vehicle to be a location of a start point of the trip, and to calculate a total navigation path subject to said location of the start point of the trip and said location of the destination of the trip and said road map data of said electronic map database;
wherein said on-vehicle main unit transmits a position information indicative of the current position of said vehicle received from said global positioning system through said wireless transceiver to a remote traffic information server so as to obtain a real-time traffic-problem location information of at least one predetermined neighboring area from said remote traffic information server through said wireless transceiver, and constitutes a district navigation path based on the part of said total navigation path within said at least one predetermined neighboring area, and determines whether said district navigation path and said traffic-problem location data overlap each other, and re-proposes said district navigation path when said district navigation path and said traffic-problem location data are found to overlap each other.

14. The vehicle dynamic navigation system as claimed in claim 13, wherein said road map data of said electronic map database includes names of multiple roads and the coordinates of a start point and an end point of each of said roads.

15. The vehicle dynamic navigation system as claimed in claim 14, wherein said remote traffic information server receives real-time traffic-problem locations in said at least one predetermined neighboring area subject to the current position of said vehicle and said update interval.

16. The vehicle dynamic navigation system as claimed in claim 15, wherein said at least one predetermined neighboring area each is a neighboring geo-zone around the current position of said vehicle.

17. The vehicle dynamic navigation system as claimed in claim 16, wherein said neighboring geo-zone is a circular area within a specific radius based on the center at the current position of said vehicle.

18. The vehicle dynamic navigation system as claimed in claim 17, wherein said specific radius is directly proportional to said update interval.

19. The vehicle dynamic navigation system as claimed in claim 18, wherein said wireless transceiver is a GPRS mobile phone.
